(19) United States
(12) Patent Application Publication
(10) Pub. No.: US 2004/0174456 A1
(43) Pub. Date: Sep. 9, 2004

(54) Image sensing apparatus, autofocus method, program, and storage medium

(76) Inventors: Yoshihiro Kobayashi, Kanagawa (JP); Yuji Sakaegi, Kanagawa (JP)

Correspondence Address: MORGAN & FINNEGAN, L.L.P., 345 PARK AVENUE, NEW YORK, NY, 10154, US

(21) Appl. No.: 10/733,478

(22) Filed: Dec. 10, 2003

(30) Foreign Application Priority Data
Dec. 13, 2002 (JP) 2002-363111(PAT.)

(51) Int. Cl. H04N 5/232; H04N 5/222

(52) U.S. Cl. 348/348; 348/350; 348/351; 348/354; 348/333.03

(57) ABSTRACT

It is an object of this invention to realize stable autofocus operation by reducing the influence of an object which is different from a main object and exists on the periphery of a distance measurement frame on the autofocus operation. In order to achieve this object, an image sensing apparatus includes an image sensing device which generates an image sensing signal by photoelectrically converting light from an object, an extraction unit which extracts a predetermined frequency component from a signal component corresponding to a focus detection area in a frame sensed by the image sensing device, a weighting circuit which weights the predetermined frequency component extracted by the extraction unit, and a driving unit which moves a focusing lens to an in-focus position on the basis of the signal weighted by the weighting circuit.

### FIELD OF THE INVENTION

The present invention relates to a technique of performing autofocus operation by using video signals in an image sensing apparatus such as a digital camera or digital video camera.

### BACKGROUND OF THE INVENTION

Conventionally, as an autofocus scheme used for image sensing equipment such as a video camera, the so-called “hill-climbing scheme” is known, in which a high-frequency component which changes in accordance with a focus state is extracted from the video signal output from an image sensing device such as a CCD, and a focusing lens is driven to maximize the level of the high-frequency component, thereby performing focus adjustment.

Such a “hill-climbing scheme” requires no special optical component for focus adjustment including a light-emitting element and the like, and can perform, for example, accurate focusing operation regardless of the distance to an object. An autofocus apparatus based on this “hill-climbing scheme” will be described with reference to FIG. 4.

Referring to FIG. 4, reference numeral 101 denotes a focusing lens which is moved in the optical axis direction by a lens driving motor 105 to perform focusing operation. Light passing through the focusing lens 101 is formed into an image on an imaging plane of an image sensing device 102 and photoelectrically converted to be output as an electrical image sensing signal. This image sensing signal is sampled/held by a CDS (Correlation Double Sampling)/AGC (Automatic Gain Control) circuit 103 and amplified to a predetermined level. The resultant signal is converted into a digital image sensing signal by an A/D converter 104. This signal is then input to an image processing circuit such as a digital camera or video camera to be converted into a standard TV signal based on the NTSC scheme or PAL scheme. In addition, a luminance signal generating circuit 110 extracts only a luminance signal component from the signal.

The extracted luminance signal is input to a gamma correction circuit 111, LPF (Low-Pass Filter) 112, HPF (High-Pass Filter) 113, and absolute value circuit ABS 114. As a consequence, a predetermined high-frequency component is extracted from the signal. A distance measurement frame generating circuit 118 extracts only a signal in a designated area from the extracted high-frequency component. An evaluation value calculation circuit then peak-holds the signal at intervals synchronized with an integer multiple of a vertical sync signal. Since this peak-held value is used for autofocus control, the peak-held value will be referred to as an AF evaluation value hereinafter. A CPU 107 sets a focusing speed corresponding to a focusing degree. More specifically, the CPU 107 controls a motor driving circuit 106 to change the rotational speed of the lens driving motor 105 so as to set a high speed if the camera is greatly out of focus, and a low speed if the camera is slightly out of focus. Meanwhile, the CPU 107 sets a motor driving direction to a direction to increase the AF evaluation value so as to increase the focusing degree. This control is called the hill-climbing control.

The following problems, however, arise in an autofocus apparatus using the above video signal. Assume that there is a main object A inside the distance measurement frame shown in FIG. 5 on which the camera should be focused, and another object B different from the main object A exists on the periphery of the distance measurement frame. In this case, the object B influences an AF evaluation value to be extracted.

In this case, if the main object A and object B are located at equal distances from the camera, no problem arises. If, however, they are located at different distances, the camera may not be focused on the main object A inside the distance measurement frame, and may be focused on the object B existing on the periphery of the distance measurement frame.

In the above situation, an AF evaluation value tends to be strongly influenced by camera shakes. If the object B comes in and goes out the distance measurement frame, the AF evaluation value varies, resulting in unstable autofocus operation.

In order to solve this problem, Japanese Patent Laid-Open No. 9-54244 has proposed a technique of realizing stable autofocus operation, when an object B different from a main object A exists on the periphery of a distance measurement frame, by extracting evaluation values from a conventional distance measurement frame and a distance measurement frame which differs in size from the conventional distance measurement frame and does not contain the object B and comparing them with each other. According to this proposal, however, if the object B exists on the periphery of a distance measurement frame B (a distance measurement frame which does not contain the object B), autofocus operation becomes unstable. Therefore, this technique cannot provide any fundamental solution.

In addition, Japanese Patent Laid-Open No. 6-268896 has proposed a technique of realizing stable autofocus operation by detecting the peak values (maximum values or minimum values) of luminance signals in a plurality of distance measurement frames and correcting focus detection signals extracted from the plurality of distance measurement frames. This proposal has greatly improved the stability of autofocus operation and actually contributed to improvements in AF precision in video cameras and digital cameras. However, when only one distance measurement frame is set or a plurality of distance measurement frames are set adjacent to each other, even this technique cannot sufficiently reduce the influences of camera shakes and the like.

### SUMMARY OF THE INVENTION

The present invention has been made under the above situation, and has as its object to realize stable autofocus operation by reducing the influence of an object which is different from a main object and exists on the periphery of a distance measurement frame on the autofocus operation.

In order to solve the above problems and achieve the above object, according to the first aspect of the present invention, there is provided an image sensing apparatus comprising an image sensing device which generates an image sensing signal by photoelectrically converting light from an object, an extraction device which extracts a predetermined frequency component from a signal component corresponding to a focus detection area in a frame sensed by the image sensing device, a weighting device which weights the predetermined frequency component extracted by the extraction device, an evaluation value calculation device which acquires a piece or pieces of information required to control a focusing lens from an output from the weighting device, and a driving device which drives a focusing lens to an in-focus position on the basis of a signal extracted by the evaluation value calculation device.

According to the second aspect of the present invention, there is provided an autofocus method comprising an image sensing step of generating an image sensing signal by photoelectrically converting light from an object, an extraction step of extracting a predetermined frequency component from a signal component corresponding to a focus detection area in a frame sensed in the image sensing step, a weighting step of weighting the predetermined frequency component extracted in the extraction step, an evaluation value calculation step of acquiring a piece or pieces of information required to control a focusing lens from an output in the weighting step, and a driving step of driving a focusing lens to an in-focus point on the basis of a signal extracted in the evaluation value calculation step.

According to the third aspect of the present invention, there is provided a program causing a computer to execute the above autofocus method.

According to the fourth aspect of the present invention, there is provided a storage medium computer-readably storing the above program.

According to the fifth aspect of the present invention, there is provided an image sensing apparatus comprising an image sensing device which generates an image sensing signal by photoelectrically converting light from an object, an extraction device which extracts a predetermined frequency component from a signal component corresponding to a focus detection area in a frame sensed by the image sensing device, a weighting device which weights the predetermined frequency component extracted by the extraction device, an evaluation value calculation device which acquires a piece or pieces of information required to control a focusing lens from an output from the weighting device, and a driving device which drives the focusing lens to an in-focus point on the basis of a signal extracted by the evaluation value calculation device, wherein the weighting device can independently set weighting factors in horizontal and vertical directions.

According to the sixth aspect of the present invention, there is provided an image sensing apparatus comprising an image sensing device which generates an image sensing signal by photoelectrically converting light from an object, an extraction device which extracts a predetermined frequency component from a signal component corresponding to a focus detection area in a frame sensed by the image sensing device, a weighting device which weights the predetermined frequency component extracted by the extraction device, an evaluation value calculation device which acquires a piece or pieces of information required to control a focusing lens from an output from the weighting device, and a driving device which drives the focusing lens to an in-focus point on the basis of a signal extracted by the evaluation value calculation device, wherein the weighting device performs relative weighting processing between adjacent distance measurement frames.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing the schematic arrangement of an image sensing apparatus according to an embodiment of the present invention;

FIG. 2 is a view showing an example of a weighting method for a case wherein a single distance measurement frame is set;

FIG. 3 is a view showing an example of a weighting method for a case wherein a plurality of distance measurement frames are set;

FIG. 4 is a block diagram showing the schematic arrangement of a conventional image sensing apparatus; and

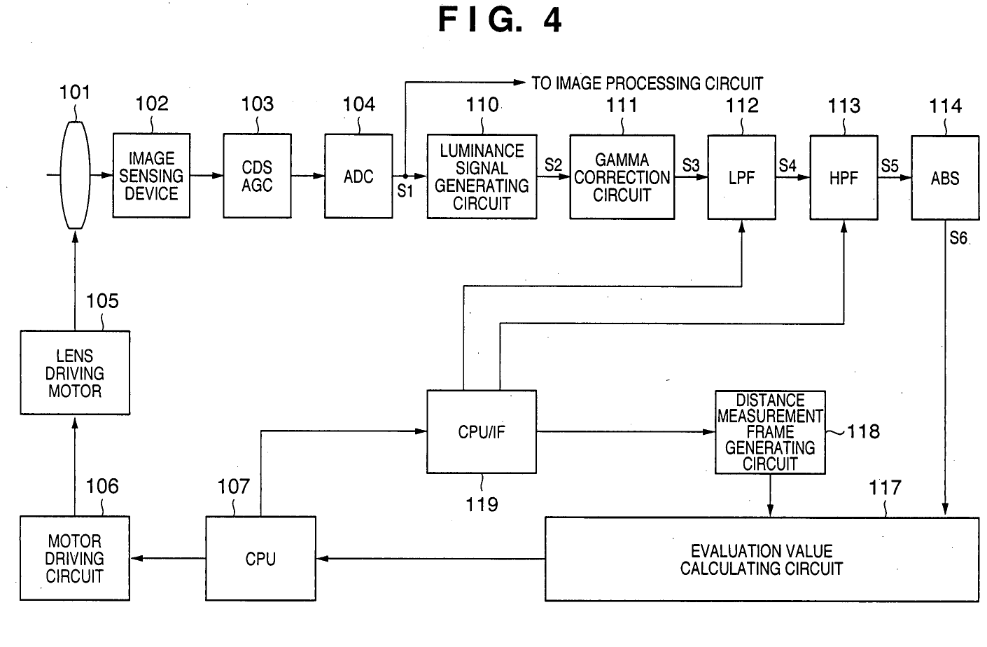

FIG. 5 is a view for explaining how an object different from a main object exists on the periphery of a distance measurement frame.

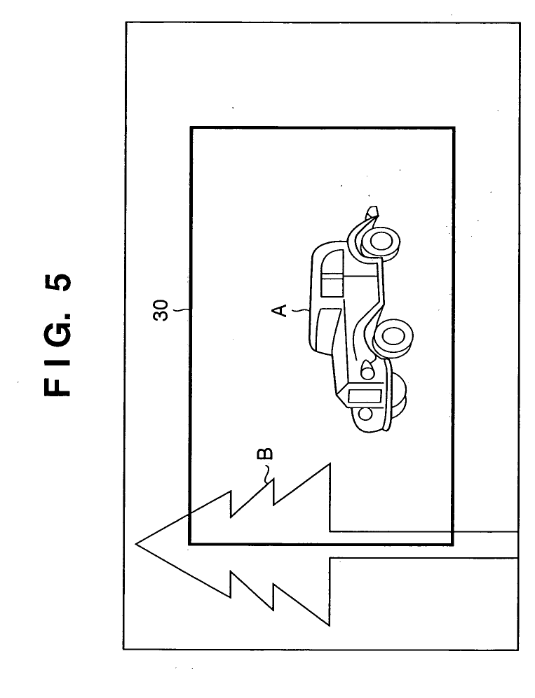

### DETAILED DESCRIPTION OF THE PREFERRED EMBODIMENTS

A preferred embodiment of the present invention will be described in detail below with reference to the accompanying drawings.

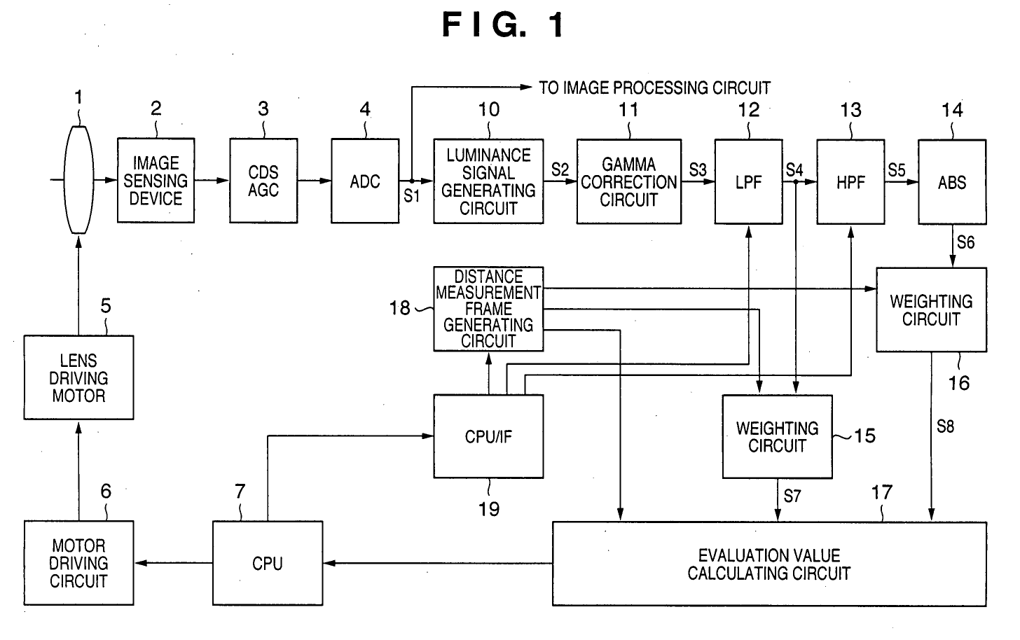

FIG. 1 is a block diagram showing the schematic arrangement of an image sensing apparatus according to an embodiment of the present invention.

Reference numeral 1 denotes a focusing lens which is moved in the optical axis direction by a lens driving motor 5 to perform focusing operation. An optical image passing through the focusing lens 1 is formed on an imaging plane of an image sensing device 2 to be photoelectrically converted and output as an electrical image sensing signal. This electrical image sensing signal is sampled/held by a CDS/AGC circuit 3, and simultaneously amplified with an optimal gain. The resultant signal is then converted into a digital signal S1 by an A/D converter 4.

When the digital signal S1 is input to the image processing circuit (not shown) of the camera, only a luminance signal component is simultaneously extracted. from the signal by a luminance signal generating circuit 10 to generate an autofocus evaluation signal S2.

The autofocus evaluation signal S2 is input to a gamma correction circuit 11, which enhances a low-luminance component and suppresses a high-luminance component to generate a gamma-converted signal S3 so as to make light input to the camera proportional to the emission intensity of a cathode-ray tube.

The gamma-converted signal S3 is input to an LPF 12 to become a signal S4 from which a low-frequency component is extracted in accordance with the filter characteristic value set by a CPU 7 through a CPU I/F 19.

The signal S4 from which the low-frequency component is extracted is input to an HPF 13, in which only a high-frequency component is extracted from the signal S4 in accordance with the filter characteristic value set by the CPU 7 through the CPU I/F 19 to generate a signal S5. This signal S5 is converted into a signal with an absolute value by an absolute value circuit 14 to generate a positive signal S6.

The signals S4 and S6 are respectively input to weighting circuits 15 and 16, which multiply the respective signals by the weighting factors designated by a distance measurement frame generating circuit 18 to generate signals S7 and S8. The calculation method used by the distance measurement frame generating circuit 18 to designate weighting factors will be described later.

The signals S7 and S8 obtained upon multiplication by the weighting factors are input to an evaluation value calculating circuit 17. The evaluation value calculating circuit 17 then calculates a plurality of evaluation values required for autofocus control in accordance with the timings designated by the distance measurement frame generating circuit 18. Evaluation values in this embodiment include TE/FE peak evaluation values, TE/FE line peak integral evaluation values, Y peak evaluation values, (Max-Min) evaluation values, and the like within a single or a plurality of distance measurement frames, as disclosed in Japanese Patent Laid-Open No. 6-268896 and the like.

The CPU 7 controls a motor driving circuit 6 by using the evaluation values for autofocus control obtained by the evaluation value calculating circuit 17 in accordance with a hill-climbing control scheme like the one described in Japanese Patent Laid-Open No. 6-268896. The motor driving circuit 6 operates the lens driving motor in accordance with an instruction from the CPU 7 to move the focusing lens to an in-focus position.

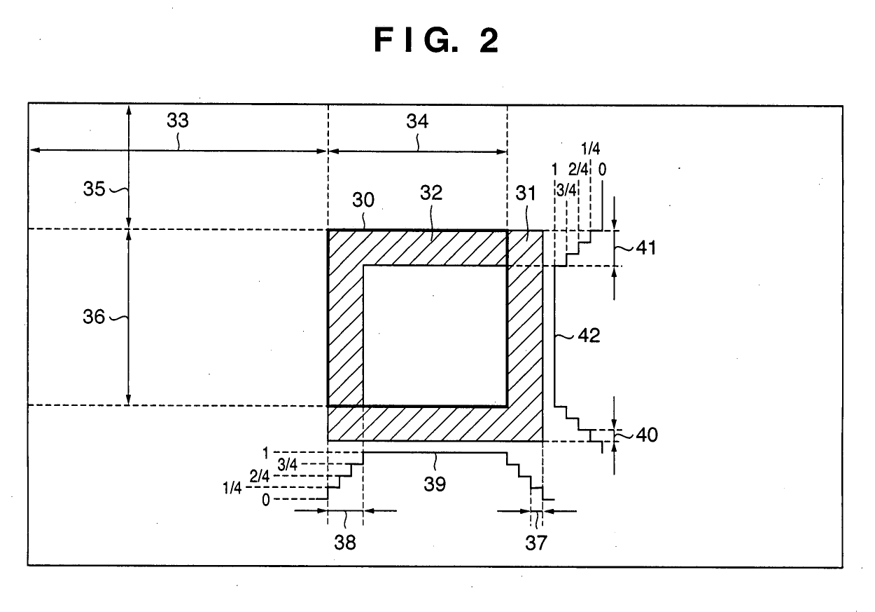

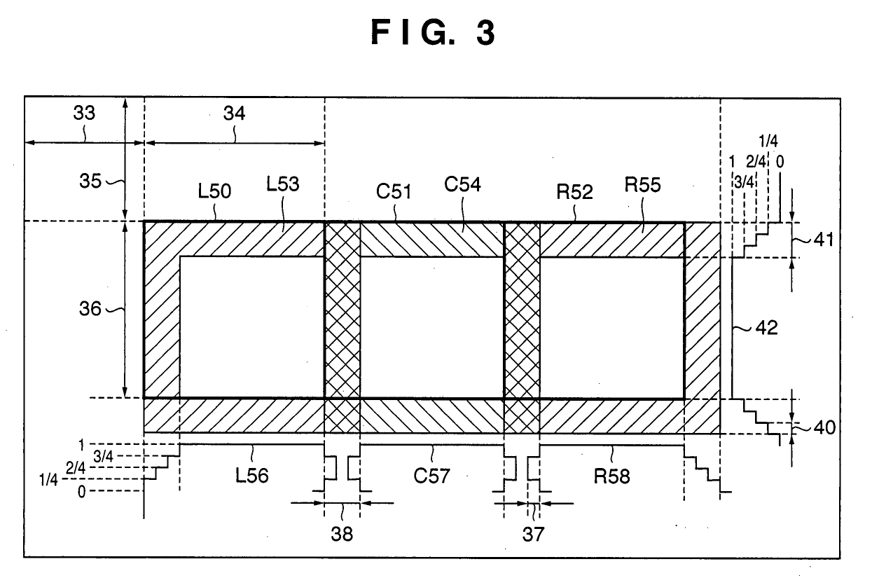

A method of determining weighting factors designated by the distance measurement frame generating circuit 18 in this embodiment will be described below with reference to FIGS. 2 and 3.

FIG. 2 is a view for explaining the method of determining weighting factors when autofocus control is to be performed with one distance measurement frame.

In contrast to a conventional distance measurement frame 30 indicated by the thick line in FIG. 2, a distance measurement frame 31 in an embodiment of the present invention has a weighting area 32 indicated by the hatching on the insides of the upper and left sides of the conventional distance measurement frame 30 and on the outsides of the right and lower sides of the frame 30.

If the signals S4 and S6 input to the weighting circuits 15 and 16 are signals within the distance measurement frame 31, the distance measurement frame generating circuit 18 determines a horizontal weighting factor 39 in accordance with a horizontal weighted pixel count 37 and horizontal weighting STEP count 38 set by the CPU 7 through the CPU I/F 19.

The horizontal weighting factor 39 changes from 0 to 1 toward the distance measurement frame center, as shown in FIG. 2. The number of steps is determined by the horizontal weighting STEP count 38; “½ steps”, “¼ steps”, “⅛ steps”, or the like can be selected. FIG. 2 shows a case wherein the weighting factor changes in ¼ steps.

Obviously, however, when, for example, a peak value of (MAX - MIN) is to be detected as described in Japanese Patent Laid-Open No. 6-268896, weighting processing needs to be performed in the reverse direction for a signal for detecting a minimum value. In this case, it is required to set a weighting factor that changes from 2 to 1 toward the distance measurement frame center.

In addition, the number of pixels in the horizontal direction in the weighting area 32 (the thickness of the weighting area in the horizontal direction) is determined by the product of the horizontal weighted pixel count 37 and the weighing step count determined by the horizontal weighting factor 39. That is, in this embodiment, the horizontal weighted pixel count 37×3 equals the number of pixels in the horizontal direction in the weighting area 32.

Likewise, if the signals S4 and S6 input to the weighting circuits 15 and 16 are signals within the distance measurement frame 31, a vertical weighting factor 42 is determined in accordance with a vertical weighted pixel count 40 and vertical weighting STEP count 41 set by the CPU 7 through the CPU I/F 19.

The vertical weighting factor 42 also changes from 0 to 1 toward the distance measurement frame center, as shown in FIG. 2. The number of steps is determined by the vertical weighting STEP count 41; “½ steps”, “¼ steps”, “⅛ steps”, or the like can be selected. FIG. 2 shows a case wherein the weighting factor changes in ¼ steps.

In addition, the number of pixels in the vertical direction in the weighting area 32 (the thickness of the weighting area in the vertical direction) is determined by the product of the vertical weighted pixel count 40 and the weighing step count determined by the vertical weighting factor 41. That is, in this embodiment, the vertical weighted pixel count 40×3 equals the number of pixels in the vertical direction in the weighting area 32.

The weighting factors 39 and 42 generated by the distance measurement frame generating circuit 18 are input to the weighting circuits 15 and 16 to be multiplied by the autofocus evaluation signals S4 and S6.

The distance measurement frame generating circuit 18 generates timing signals like those described in an embodiment in Japanese Patent Laid-Open No. 6-268896, which represent whether the signals S7 and S8 input to the evaluation value calculating circuit 17 are signals within the distance measurement frame 31, to which portions of the distance measurement frame 31 the signals correspond, and the like, in accordance with a distance measurement frame horizontal position 33, a distance measurement frame horizontal pixel count 34, a distance measurement frame vertical position 35, a distance measurement frame vertical pixel count 36, the horizontal weighted pixel count 37, the horizontal weighting STEP count 38, the vertical weighted pixel count 40, and the vertical weighting STEP count 41. The distance measurement frame generating circuit 18 then sends an instruction to the evaluation value calculating circuit 17.

The evaluation value calculating circuit 17 extracts a plurality of evaluation values like those described in the embodiment in Japanese Patent Laid-Open No. 6-268896 from the signals S7 and S8 output from the weighting circuits 15 and 16 in accordance with the timing signals from the distance measurement frame generating circuit 18.

Since the autofocus evaluation signals S4 and S6 are input to the evaluation value calculating circuit 17 after being multiplied by the weighting factors 38 and 42 generated by the distance measurement frame generating circuit 18, even if an object B different from a main object A exists on the periphery of the distance measurement frame 31, the influence of the object B on the autofocus evaluation values can be reduced. When the object B comes in and goes out the distance measurement frame 31 due to camera shakes or the like, in particular, the influence of variations in evaluation value on autofocus operation can be reduced.

FIG. 3 is a view for explaining a method of determining weighting factors when autofocus control is to be performed by using a plurality of distance measurement frames.

In contrast to the conventional three distance measurement frames indicated by the thick lines in FIG. 3, a distance measurement frame L50, distance measurement frame C51, and distance measurement frame R52 in this embodiment of the present invention respectively have a weighting area L53, weighting area C54, and weighting area R55 indicated by the. hatchings on the insides of the upper and left sides of the respective conventional distance measurement frames and on the outsides of the right and lower sides of the frames.

If the signals S4 and S6 input to the weighting circuits 15 and 16 are signals within the distance measurement frame L50, the distance measurement frame generating circuit 18 determines a horizontal weighting factor L56 in accordance with the horizontal weighted pixel count 37 and horizontal weighting STEP count 38 set by the CPU 7 through the CPU I/F 19.

Likewise, if the signals S4 and S6 input to the weighting circuits 15 and 16 are signals within the distance measurement frame C51, the distance measurement frame generating circuit 18 determines a horizontal weighting factor C57 in accordance with the horizontal weighted pixel count 37 and horizontal weighting STEP count 38 set by the CPU 7 through the CPU I/F 19.

Likewise, if the signals S4 and S6 input to the weighting circuits 15 and 16 are signals within the distance measurement frame R52, the distance measurement frame generating circuit 18 determines a horizontal weighting factor R58 in accordance with the horizontal weighted pixel count 37 and horizontal weighting STEP count 38 set by the CPU 7 through the CPU I/F 19.

The horizontal weighting factor L56, horizontal weighting factor C57, and horizontal weighting factor R58 each change from 0 to 1 toward the distance measurement frame center, as shown in FIG. 3. The number of steps is determined by the horizontal weighting STEP count 38; “½ steps”, “¼ steps”, “⅛ steps”, or the like can be selected. FIG. 3 shows a case wherein each weighting factor changes in ¼ steps.

In addition, the number of pixels in the horizontal direction in each of the weighting areas L53, C54, and R55 is determined by the product of the horizontal weighted pixel count 37 and the weighing step count determined by the horizontal weighting factor 39. That is, in this embodiment, the horizontal weighted pixel count 37×3 equals the number of pixels in the horizontal direction in each of the weighting areas L53, L54, and R55.

Likewise, if the signals S4 and S6 input to the weighting circuits 15 and 16 are signals within the distance measurement frame L50, C51, or R52, the vertical weighting factor 42 is determined in accordance with the vertical weighted pixel count 40 and vertical weighting STEP count 41 set by the CPU 7 through the CPU I/F 19.

The vertical weighting factor 42 also change from 0 to 1 toward the distance measurement frame center, as shown in FIG. 3. The number of steps is determined by the vertical weighting STEP count 41; “½ steps”, “¼ steps”, “⅛ steps”, or the like can be selected. FIG. 2 shows a case wherein each weighting factor changes in ¼ steps.

In addition, the number of pixels in the vertical direction in each of the weighting areas L53, C54, and R55 is determined by the product of the vertical weighted pixel count 40 and the weighing step count determined by the vertical weighting factor 41. That is, in this embodiment, the vertical weighted pixel count 40×3 equals the number of pixels in of the vertical direction in each weighting area.

The weighting factors L56, C57, R58, and 42 generated by the distance measurement frame generating circuit 18 are input to the weighting circuits 15 and 16 to be multiplied by the autofocus evaluation signals S4 and S6.

The distance measurement frame generating circuit 18 generates timing signals like those described in an embodiment in Japanese Patent Laid-Open No. 6-268896, which represent whether the signals S7 and S8 input to the evaluation value calculating circuit 17 are signals within the distance measurement frame 31, to which portions of the distance measurement frame 31 the signals correspond, and the like, in accordance with the distance measurement frame horizontal position 33, distance measurement frame horizontal pixel count 34, distance measurement frame vertical position 35, distance measurement frame vertical pixel count 36, horizontal weighted pixel count 37, horizontal weighting STEP count 38, vertical weighted pixel count 40, and vertical weighting STEP count 41. The distance measurement frame generating circuit 18 then sends an instruction to the evaluation value calculating circuit 17.

The evaluation value calculating circuit 17 extracts a plurality of evaluation values like those described in the embodiment in Japanese Patent Laid-Open No. 6-268896 from the signals S7 and S8 output from the weighting circuits 15 and 16 in accordance with the timing signals from the distance measurement frame generating circuit 18.

Since the autofocus evaluation signals S4 and S6 are input to the evaluation value calculating circuit 17 after being multiplied by the weighting factors L56, C57, R58, and 42 generated by the distance measurement frame generating circuit 18, even if an object B different from a main object A exists on the periphery of one of the distance measurement frames L50, C51, and R52, the influence of the object B on the autofocus evaluation values can be reduced. When the object B comes in and goes out one of the distance measurement frames L50, C51, and R52 due to camera shakes or the like, in particular, the influence of variations in evaluation value on autofocus operation can be reduced.

As shown in FIG. 3, when a weighting method near the boundaries between the distance measurement frame L50, the distance measurement frame C51, and the distance measurement frame R52 satisfies the following relation, even if an object B different from a main object A exists near one of the boundaries between the distance measurement frame L50, the distance measurement frame C51, and the distance measurement frame R52, the influence of the object B on autofocus evaluation values can be reduced:

weighting factor on decrease=1−weighting factor on increase

Even if the object B slightly moves near one the boundaries between the distance measurement frame L50, the distance measurement frame C51, and the distance measurement frame R52, the influence of variations in evaluation value on the selection of a distance measurement frame is reduced, thereby allowing stabler autofocus control.

This embodiment has exemplified the case wherein the distance measurement frame L50, the distance measurement frame C51, and the distance measurement frame R52 are adjacent to each other. Even if, however, distance measurement frames are set at predetermined intervals, making each distance measurement frame have the arrangement shown in FIG. 2 can reduce the influence of variations in evaluation value on autofocus operation which are caused by the presence of an object near the periphery of one of the distance measurement frames.

Furthermore, this embodiment has exemplified only the case wherein the number of distance measurement frames in the vertical direction is one. However, even in an autofocus apparatus using a plurality of distance measurement frames in the vertical direction, the use of a similar method can reduce the influence of variations in evaluation value on autofocus operation which are caused by an object existing near the periphery of one of the distance measurement frames or one of the boundaries therebetween.

As described above, according to the image sensing apparatus of this embodiment, in calculating autofocus evaluation values, even if an object B different from a main object A exists on the periphery of a distance measurement frame, the influence of the object B on autofocus evaluation values can be reduced by performing weighting processing for signals from which the evaluation values are to be calculated. This is the effect obtained by decreasing the sensitivity near the periphery of the distance measurement frame. Even if the object B comes in and goes out the distance measurement frame, in particular, the influence of variations in evaluation value can be reduced, thereby allowing stable autofocus operation.

[Other Embodiment]

The present invention can be applied to a system constituted by a plurality of devices, or to an apparatus comprising a single device, or to a system designed to perform processing through a network such as a LAN.

The objects of the respective embodiments are also achieved by supplying a storage medium (or a recording medium), which records a program code of software that can realize the functions of the above embodiments to the system or apparatus, and reading out and executing the program code stored in the storage medium by a computer (or a CPU or MPU) of the system or apparatus. In this case, the program code itself read out from the storage medium realizes the functions of the above embodiments, and the storage medium which stores the program code constitutes the present invention. The functions of the above embodiments may be realized not only by executing the readout program code by the computer but also by some or all of actual processing operations executed by an OS (operating system) running on the computer on the basis of an instruction of the program code.

Furthermore, obviously, the functions of the above embodiments can be realized by some or all of actual processing operations executed by a CPU or the like arranged in a function extension card or a function extension unit, which is inserted in or connected to the computer, after the program code read out from the storage medium is written in a memory of the extension card or unit.

When the present invention is to be applied to the above storage medium, program codes corresponding to the sequences described above are stored in the storage medium.

As has been described above, according to the above embodiments, the influence of an object which is different from a main object and exists on the periphery of a distance measurement frame on autofocus operation can be reduced, and stable autofocus operation can be realized.

The present invention is not limited to the above embodiments and various changes and modifications can be made within the spirit and scope of the present invention. Therefore, to apprise the public of the scope of the present invention, the following claims are made.

What is claimed is:

1. An image sensing apparatus comprising:
an image sensing device which generates an image sensing signal by photoelectrically converting light from an object;
an extraction device which extracts a predetermined frequency component from a signal component corresponding to a focus detection area in a frame sensed by said image sensing device;
a weighting device which weights the predetermined frequency component extracted by said extraction device;
an evaluation value calculation device which acquires a piece or pieces of information required to control a focusing lens from an output from said weighting device; and
a driving device which drives the focusing lens to an in-focus point on the basis of a signal extracted by said evaluation value calculation device.

2. The apparatus according to claim 1, wherein a weighting factor calculated by said weighting device changes in a predetermined number of steps from a peripheral portion to a central portion of the focus detection area.

3. The apparatus according to claim 2, wherein the weighting factor and the predetermined number of steps can be independently set in horizontal and vertical directions of the frame.

4. The apparatus according to claim 1, wherein the focus detection area comprises a plurality of focus detection areas, and said weighting device performs relative weighting processing between the adjacent focus detection areas.

5. An autofocus method comprising:
an image sensing step of generating an image sensing signal by photoelectrically converting light from an object;
an extraction step of extracting a predetermined frequency component from a signal component corresponding to a focus detection area in a frame sensed in the image sensing step;
a weighting step of weighting the predetermined frequency component extracted in the extraction step;
an evaluation value calculation step of acquiring a piece or pieces of information required to control a focusing lens from an output in the weighting step; and
a driving step of driving a focusing lens to an in-focus point on the basis of a signal extracted in the evaluation value calculation step.

6. The method according to claim 5, wherein a weighting factor calculated in the weighting step changes in a predetermined number of steps from a peripheral portion to a central portion of the focus detection area.

7. The method according to claim 6, wherein the weighting factor and the predetermined number of steps can be independently set in horizontal and vertical directions of the frame.

8. The method according to claim 5, wherein the focus detection area comprises a plurality of focus detection areas, and in the weighting step, relative weighting processing is performed between the adjacent focus detection areas.

9. A program causing a computer to execute an autofocus method defined in claim 5.

10. A storage medium computer-readably storing a program defined in claim 9.

11. An image sensing apparatus comprising:
an image sensing device which generates an image sensing signal by photoelectrically converting light from an object;
an extraction device which extracts a predetermined frequency component from a signal component corresponding to a focus detection area in a frame sensed by said image sensing device;
a weighting device which weights the predetermined frequency component extracted by said extraction device;
an evaluation value calculation device which acquires a piece or pieces of information required to control a focusing lens from an output from said weighting device; and
a driving device which drives the focusing lens to an in-focus point on the basis of a signal extracted by said evaluation value calculation device,
wherein said weighting device can independently set weighting factors in horizontal and vertical directions.

12. An image sensing apparatus comprising:
an image sensing device which generates an image sensing signal by photoelectrically converting light from an object;
an extraction device which extracts a predetermined frequency component from a signal component corresponding to a focus detection area in a frame sensed by said image sensing device;
a weighting device which weights the predetermined frequency component extracted by said extraction device;
an evaluation value calculation device which acquires a piece or pieces of information required to control a focusing lens from an output from said weighting device; and
a driving device which drives the focusing lens to an in-focus point on the basis of a signal extracted by said evaluation value calculation device,
wherein said weighting device performs relative weighting processing between adjacent distance measurement frames.
